(19) United States
(12) Patent Application Publication
(10) Pub. No.: US 2026/0245333 A1
(43) Pub. Date: Aug. 20, 2026

(54) COMPUTER SYSTEM, DATA PROCESSING METHOD AND A NON-TRANSITORY COMPUTER READABLE MEDIUM

(71) Applicant: Hitachi, Ltd., Tokyo (JP)

(72) Inventors: Takahiro NARUKO, Tokyo (JP); Hiroaki AKUTSU, Tokyo (JP)

(21) Appl. No.: 19/531,235

(22) Filed: Feb. 5, 2026

(30) Foreign Application Priority Data
Feb. 20, 2025 (JP) 2025-025829

(51) Int. Cl. G06V 10/26; G06T 3/40; G06V 10/25; G06V 10/28; G06V 10/764; G06V 10/82

(52) U.S. Cl. CPC G06V 10/26; G06T 3/40; G06V 10/25; G06V 10/28; G06V 10/764; G06V 10/82

(57) ABSTRACT

A computer system includes one or more computers to analyze data, and the computer includes a memory configured to store a program, and a processor configured to perform processing according to the program. The processor executes the program to perform: detection processing of detecting, when the data is input, a portion that satisfies a condition specified by a user from the data and generating first data indicating a position of the portion in the data; cut-out processing of cutting out, from the data, the portion indicated by the first data and generating second data; and analysis processing of analyzing the second data.

### CROSS-REFERENCE TO RELATED APPLICATION

The present application claims priority from Japanese application JP2025-025829, filed on Feb. 20, 2025, the content of which is hereby incorporated by reference into this application.

The present disclosure relates to a technology for improving data calculation efficiency.

### BACKGROUND

A method is known for analyzing multimedia data including a plurality of media as a means for expressing, for instance, an image such as a video or a still image, a text, and audio by using an AI (Artificial Intelligence) such as a neural network. For example, image classification using a ViT (Vision Transformer) is known. Meanwhile, a RAG (Retrieval Augmented Generation) technology is known for improving the accuracy of image classification by using individually stored data as external information for a generative AI. Currently, RAG is mainly targeted at text data, but it is expected that RAG will be increasingly adapted to the multimedia data.

However, the multimedia data has a large data capacity and tends to have a larger amount of stored data and a longer analysis processing time. Therefore, it is challenging to reduce the amount of stored multimedia data and reduce the analysis processing time.

An example of a compression technology for reducing the amount of stored multimedia data is disclosed in Japanese Patent Application Publication No. 2024-145685. A data compression method disclosed in Japanese Patent Application Publication No. 2024-145685 allocates a larger number of bits to the area of an object type, which is the type of the object specified by a user, to achieve a high image quality, while allowing image quality deterioration in the area other than that of the object type to highly compress image data. This achieves a high compression ratio and reduces the amount of stored data.

Meanwhile, for data for industrial use, it may not be necessary to reproduce all the information contained in the data with high fidelity after compression and decompression. For example, in the case of inspecting a power transmission tower by using video data captured by a drone, a high image quality is required for an area showing the power transmission tower, but image quality deterioration is allowed in an area of background vegetation or the like. It is conceivable to control a bit allocation amount so as to provide an area, where the object type exists, with a high image quality by applying the technology disclosed in Japanese Patent Application Publication No. 2024-145685 to the video data, and highly compress the area other than that of the object type. In this case, it is possible to obtain the image quality required to inspect the object type, and also reduce the amount of stored data.

### SUMMARY

When the data compression technology disclosed in Japanese Patent Application Publication No. 2024-145685 is applied to image data, the amount of stored data can be reduced, but an effect of reducing the analysis processing time cannot be expected. The reason for this is that the image data to be subjected to analysis processing is uncompressed data. This problem occurs not only when an analysis target is the image data, but also similarly occurs when the analysis target is another data such as a text or audio.

An object included in the present disclosure is to provide a computer system, a data processing method and a non-transitory computer readable medium storing a program which reduce data analysis processing time.

A computer system according to an aspect included in the present disclosure is a computer system including one or more computers to analyze data, wherein at least one of the computers includes: a memory configured to store a program; and a processor configured to perform processing according to the program, and wherein the processor executes the program to perform: detection processing of detecting, when the data is input, a portion that satisfies a condition specified by a user from the data, and generating first data indicating a position of the portion in the data; cut-out processing of cutting out, from the data, the portion indicated by the first data, and generating second data; and analysis processing of analyzing the second data.

According to the aspect included in the present disclosure, it is only needed to analyze the second data obtained by cutting out the portion of the input data that satisfies the condition specified by the user in the analysis processing, and therefore analysis processing time can be reduced.

### BRIEF DESCRIPTION OF THE DRAWINGS

FIG. 1 is a block diagram illustrating a configuration example of a computer system in a first embodiment;

FIG. 2 is a diagram illustrating an example of a hardware configuration of a server in the first embodiment;

FIG. 3 is a diagram illustrating an example of information stored in the memory shown in FIG. 2;

FIG. 4 is a diagram illustrating an example of the object specification information management table shown in FIG. 3;

FIG. 5 is a flow chart illustrating an example of the operation procedure of the detection processing unit shown in FIG. 1;

FIG. 6 is a flow chart illustrating an example of the operation procedure of the cut-out processing unit shown in FIG. 1;

FIG. 7 is a diagram showing the case where an example of an image in a detection result is represented at two-dimensional coordinates;

FIG. 8 is a diagram showing an example of flows of processing in the cut-out processing unit and an analysis processing unit in a first modification;

FIG. 9 is a diagram showing an example of flows of the processing in the cut-out processing unit and the analysis processing unit in a second modification;

FIG. 10 is a block diagram illustrating a configuration example of a computer system in a second embodiment;

FIG. 11 is a block diagram illustrating a configuration example of a computer system in a third embodiment; and

FIG. 12 is a block diagram illustrating a configuration example of a computer system in a fourth embodiment.

### DETAILED DESCRIPTION OF THE EMBODIMENT

Referring to the drawings, embodiments of a computer system in the present embodiment will be described. Hereinbelow, the same or similar components or functions are denoted by the same reference signs, and a repetitive description thereof is omitted.

### First Embodiment

### Configuration

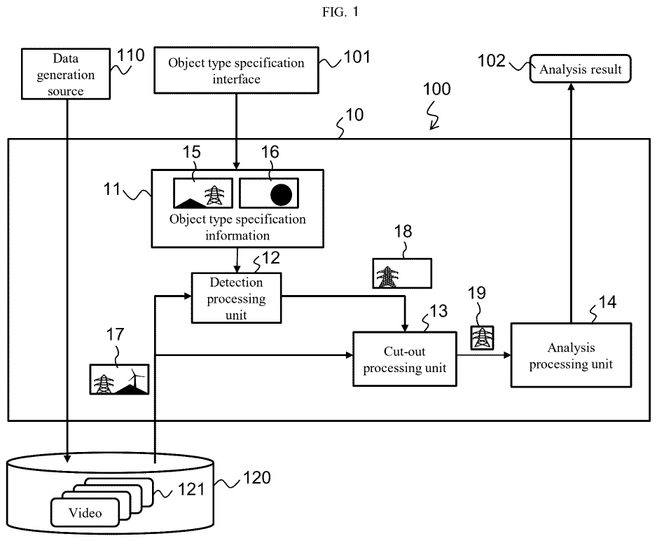

Referring to FIG. 1, a description will be given of a general outline of the computer system in the first embodiment. FIG. 1 is a block diagram illustrating a configuration example of the computer system in the first embodiment. A computer system 100 includes a data generation source 110, a server 10, and a storage apparatus 120. The server 10 is connected to the storage apparatus 120. To the server 10, an object type specification interface 101 is coupled.

The data generation source 110 is a main body that generates data that may be subject to compression. The data generation source 110 is, e.g., an image sensor that generates a video. In the first embodiment, for ease of description, the description is given of the case where the data generation source 110 is the image sensor that generates a video, but the data generation source 110 is not limited to the image sensor that generates a video, and data to be generated is not limited to a video.

For example, the data generation source 110 may also be an image sensor that generates a still image, and may also be a sensor such as a vibration sensor that generates one-dimensional time series data. The data generation source 110 is not limited to a sensor, and may also be configured to include a software program and a processor that executes the program. The software program is, e.g., a computer graphics software program for generating a video or a still image.

The data generated by the data generation source 110 may also be data which is generated by the sensor or software program and then processed. An example of the processed data is a Segmentation Map obtained by applying a Semantic Segmentation machine learning model (hereinafter referred to as the SS model) to each of frames in a video. The SS model is an example of a model for image classification, which has difficulty in distinguishing overlapping objects from each other, but has an advantage of being able to detect an amorphous area such as sky or a road. The data generated by the data generation source 110 may also be a video file stored in a recording device or the like. While FIG. 1 shows the case where the single data generation source 110 is provided, but a plurality of the data generation sources 110 may also be provided in the computer system 100.

The object type specification interface 101 is an interface for the user to specify data representing the type of an object. The object type specification interface 101 is configured to include an input device such as, e.g., a mouse, a keyboard, or a touch panel, an output device such as a display or a speaker, and a software program to be implemented by the processor. The data representing the type of the object is, e.g., object type specification information 11. Details of the object type specification information 11 will be described later.

The storage apparatus 120 is a storage apparatus for storing therein image data, such as video data 121, generated by the data generation source 110. The storage apparatus 120 is a HDD (Hard Disk Drive) or a SSD (Solid State Drive). The storage apparatus 120 is not limited to a block device configured of the HDD or SSD, and may also be a file storage, a content storage, or a volume constructed on a storage system. The storage apparatus 120 needs only to be an apparatus that stores data by any method.

The video data 121 may be stored directly in the storage apparatus 120 by the data generation source 110, or may also be received by the server 10 from the data generation source 110, and then stored in the storage apparatus 120 from the server 10. The video data 121 may also be tensor-format data in which each of frames 17 is represented in a Raw format, and may also be data compressed according to a video compression standard such as H.264. The video data 121 may also be data configured to include any bit string that represents a video as another data configuration. A description will be given below by using the case of tensor-format data in which each of the plurality of frames 17 included in the video data 121 is represented in the Raw format. Specifically, the description will be given by using the case of three-dimensional tensor data in which image data in each one of the frames 17 is configured of Height×Width×RGB.

A configuration of the server 10 shown in FIG. 1 will be described. The server 10 is an example of an information processing apparatus that implements a data processing method in the first embodiment. The server 10 includes a detection processing unit 12, a cut-out processing unit 13, and an analysis processing unit 14. The server 10 stores object type specification information 11 as management information. The object type specification information 11 is configured of a pair of a sample image 15 showing, e.g., the object type specified by the user and a mask image 16, which is an image of mask data indicating an area showing the object type in the sample image 15. Hereinbelow, this pair is referred to as a support set.

By way of example, the object type specification information 11 shown in FIG. 1 shows the case where the object type is a “power transmission tower”. In the shown case, the mask data in FIG. 1 is the mask image 16 covering the portion of the “power transmission tower”, but the mask data may also be text data such as “Power Transmission Tower”. The object type specification information 11 is configured by the user via the object type specification interface 101.

The detection processing unit 12 detects, for each of the plurality of frames 17 included in the video data 121, the area of the object type specified by the object type specification information 11, and transmits a detection result 18 to the cut-out processing unit 13. For example, the detection processing unit 12 inputs the object type specification information 11 and the frame 17 to a Semantic Segmentation deep learning model using a Few-shot learning technology (hereinafter referred to as the FSS model). The FSS model is a model with improved prediction accuracy obtained by training an SS model by using a small number of labeled samples.

The FSS model transforms the image data in each of the frames 17 to binary data including a first value indicating a pixel representing the object type and a second value indicating a pixel representing the area other than that of the object type, and outputs the binary data. The detection processing unit 12 transmits the output of the FSS model as the detection result 18 to the cut-out processing unit 13. The detection result 18 is Height×Width×Binary Value two-dimensional tensor data for the frame 17. Hereinbelow, the first value indicating that the object type has been detected in each of the pixels in the detection result 18 is expressed as positive, while the second value indicating that the object type has not been detected therein is expressed as negative. The two-dimensional tensor data in the detection result 18 corresponds to first data.

Note that, when the video data 121 stored in the storage apparatus 120 is compressed data, the frame 17 input to the server 10 is decompressed by a decoder (not shown). A detailed description of processing by the decoder is omitted herein.

Processing of detecting the area of the object type from each of the frames 17 is not limited to the processing using the FSS model. The detection processing unit 12 may also use, instead of the FSS model, e.g., the SS model that detects the area of the object type hard-coded in advance in the frame 17. Alternatively, in another method, the detection processing unit 12 may also detect an area with a predetermined luminosity as the area of the object type in the frame 17. In this case, the object type specification interface 101 and the object type specification information 11 need not necessarily be provided. The object type detection processing is not limited to the method described above, and needs only to be any processing that receives the frame 17 as an input and outputs the detection result 18.

When the frame 17 and the detection result 18 are input thereto, the cut-out processing unit 13 cuts out, from the image of the frame 17, an image including the area of the positive pixel where the object type is detected in the detection result 18. For example, the cut-out processing unit 13 cuts out, from the frame 17, a minimum rectangle including the positive pixel in the detection result 18. The cut-out processing unit 13 transmits a cut-out image 19, which is the image cut out from the frame 17, to the analysis processing unit 14. The cut-out image 19 corresponds to second data. Note that the cut-out processing is not limited to the method described above.

When receiving the cut-out image 19 from the cut-out processing unit 13, the analysis processing unit 14 performs analysis processing on the cut-out image 19, and outputs an analysis result 102. For example, the analysis processing unit 14 classifies the image by using a neural network such as ResNet (Residual Network) or ViT. Specifically, the analysis processing unit 14 inputs the cut-out image 19 to a neural network model, and outputs a processing result of the image classification output from the neural network as the analysis result 102. Alternatively, when receiving the cut-out image 19 from the cut-out processing unit 13, the analysis processing unit 14 may also perform caption generation processing of generating a text describing what is displayed in the cut-out image 19 by using the neural network. However, the analysis processing unit 14 is not limited to the case where the processing is performed by using the method described above, and may also perform the analysis processing by using any other method.

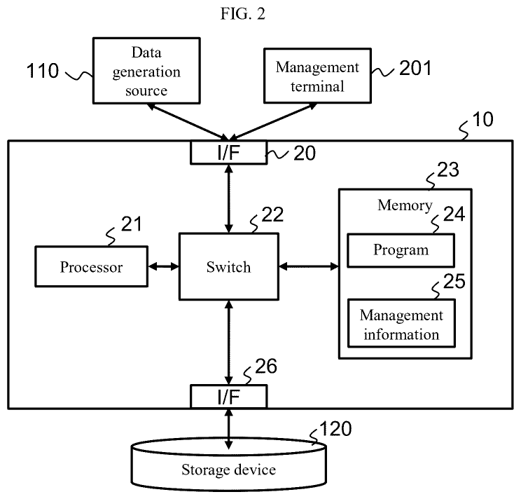

Next, referring to FIG. 2, an example of the hardware configuration of the server 10 will be described. FIG. 2 is a diagram illustrating the example of the hardware configuration of the server in the first embodiment. FIG. 2 illustrates the hardware configuration of the server 10 that performs processing in each of the units described with reference to FIG. 1, and holds management information 25. The server 10 includes a processor 21, a switch 22, a memory 23, a front-end interface 20, and a back-end interface 26. The processor 21 is coupled to each of the memory 23, the front-end interface 20, and the back-end interface 26 via the switch 22.

The front-end interface 20 is an interface for coupling the server 10 to the data generation source 110 and to a management terminal 201. The management terminal 201 is an information processing apparatus such as a PC (Personal Computer) operated by the user. The object type specification interface 101 shown in FIG. 1 is provided in the management terminal 201. The back-end interface 26 is an interface for coupling the server 10 to the storage apparatus 120.

The processor 21 performs the functions of a control apparatus that controls the entire server 10 and an arithmetic apparatus that implements the data processing method in the first embodiment. The processor 21 is a general-purpose computing device, an accelerator, a hardware encoder/decoder, or a configuration obtained by combining these with each other. The general-purpose computing device is a CPU (Central Processing Unit). The accelerator is a GPU (Graphical Processing Unit), an FPGA (Field Programmable Gate Array), or the like. The hardware encoder/decoder is, e.g., a hardware encoder/decoder according to a standard codec such as, e.g., HEVC (High Efficiency Video Codec).

The memory 23 stores a program 24 to be executed by the processor 21 and the management information 25 to be used when the processor 21 executes the program 24. The memory 23 is used also as a work area. The memory 23 is a nonvolatile memory such as, e.g., a flash memory. The memory 23 may also store a program such as an OS (Operating System) and information related to the program.

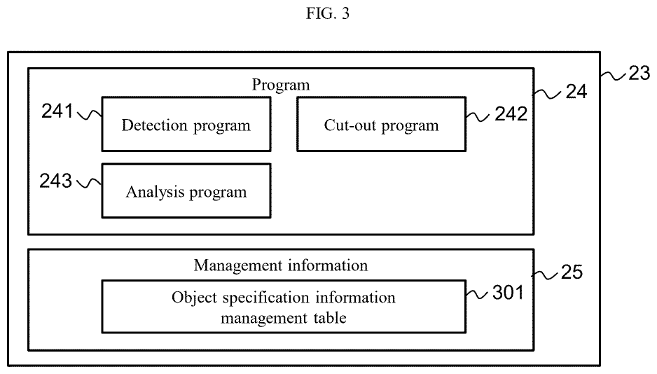

FIG. 3 is a diagram illustrating an example of information to be stored in the memory shown in FIG. 2. The memory 23 stores, as the program 24, a detection program 241, a cut-out program 242, and an analysis program 243. The detection program 241 is a program that implements the detection processing by the detection processing unit 12. The cut-out program 242 is a program that implements the cut-out processing by the cut-out processing unit 13. The analysis program 243 is a program that implements the analysis processing by the analysis processing unit 14. The memory 23 stores, as the management information 25, an object specification information management table 301. The object specification information management table 301 is data for managing the object type specification information 11.

Through the execution of the detection program 241 by the processor 21, the function of the detection processing unit 12 shown in FIG. 1 is performed. Through the execution of the cut-out program 242 by the processor 21, the function of the cut-out processing unit 13 shown in FIG. 1 is performed. Through the execution of the analysis program 243 by the processor 21, the function of the analysis processing unit 14 shown in FIG. 1 is performed. A configuration including at least the processor 21 and the memory 23 functions as one computer.

FIG. 3 illustrates a case where the program 24 is stored in the memory 23, but the program 24 may also be stored in advance on a recording medium (not shown) such as a DVD (Digital Versatile Disc), and installed from the recording medium to the server 10. Alternatively, the program 24 may also be stored on the HDD or SSD of an external server (not shown), and delivered from the external server to the server 10 via a network such as the Internet. Meanwhile, the neural network such as the FSS model may also be stored in the memory 23 shown in FIG. 2, or may also be stored in the external server (not shown). When the neural network is stored in the external server (not shown), the processor 21 needs only to use the neural network by being coupled to the external server via a network such as the Internet.

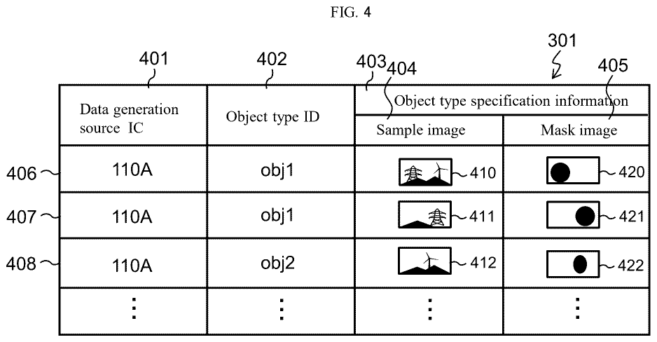

FIG. 4 is a diagram illustrating an example of the object specification information management table shown in FIG. 3. The object specification information management table 301 is, e.g., tabular data. The object specification information management table 301 has fields for a data generation source ID 401, an object type ID 402, and object type specification information 403. The object type specification information 403 has fields for a sample image 404 and a mask image 405. The fields included in the entry shown in FIG. 4 are exemplary, and are not limited to the items shown in FIG. 4.

The data generation source ID 401 is the field in which the identifier of the data generation source 110 is stored. The identifier of the data generation source 110 is, e.g., a character string configured by the user, or a MAC (Media Access Control) address or an IP (Internet Protocol) address allocated to the data generation source 110. The identifier of the data generation source 110 may also be any code that allows an address or a path on the storage apparatus 120 or the data generation source 110 to be identified. However, when the single data generation source 110 is provided, there is no need for the user to specify the single data generation source 110 from among a plurality of the data generation sources 110, and therefore the entry need not necessarily be provided with the field for the data generation source ID 401.

The object type ID 402 is the field in which the identifier of the object type is stored. The identifier of the object type is, e.g., a character string configured by the user. The identifier of the object type is not limited to the case of being configured by the user. When there is only one set of the object type specification information 403 to be configured with respect to the one object type, the object type ID 402 need not necessarily be provided.

The object type specification information 403 is the field in which two images for specifying the object type corresponding to the object type ID 402 of each of the data generation source IDs 401 are stored. The two images are the sample image 404 and the mask image 405. For example, the sample image 404 is an image including the object type specified by the user. The mask image 405 is, e.g., a monochrome image in which a predetermined value is allocated to an area showing the object type specified by the user in the sample image 404.

Note that the mask image 405 is not limited to the configuration described above. The mask image 405 may also be an XML (Extensible Markup Language) that stores the coordinates and size of a Bounding Box representing the position of the area showing the object type. The mask image 405 is not limited to an XML data format, and may also be in any other data format. The object type specification information 403 may also be text data representing the object type in natural language. The object type specification information 403 is not limited to the support set including the sample image 404 and the mask image 405, and may also be data obtained by transforming the text data mentioned above.

Referring to FIG. 4, a specific example of information stored in the object specification information management table 301 will be described herein. FIG. 4 illustrates the case where, for the data generation source to which an identifier “110A” is allocated, two object types having object type IDs “obj1” and “obj2” are specified by the object type specification information registered in rows 406 to 408.

The object type to which the identifier “obj1” is allocated is a power transmission tower. The power transmission tower is specified by two pairs of object type specification information, which are a support set including a sample image 410 and a mask image 420 and a support set including a sample image 411 and a mask image 421. For example, the sample image 410 includes the power transmission tower and a wind power generator, and the power transmission tower is specified by the mask image 420. Meanwhile, the object type to which the identifier “obj2” is allocated is the wind power generator. The wind power generator is specified by the object type specification information using a support set including a sample image 412 and a mask image 422.

Note that FIG. 4 shows the case where the data generation source ID 401, the object type ID 402, and the object type specification information 403 are represented by one table, but a relationship among these items is not limited to the case of being represented by one table. The relationship among these items may also be represented by two separate tables, which are a first table that associates the data generation source ID 401 with the object type ID 402 and a second table that associates the object type ID 402 with the object type specification information 403. In this case, the object type specification information 403 of any object type can be shared by the plurality of data generation sources 110.

The object specification information management table 301 described with reference to FIG. 4 is exemplary, and needs only to have a data structure that allows information specifying the object type to be managed. The data structure that manages the information specifying the object type may also be a data structure other than that in a tabular format, and examples thereof include XML, YAML (YAML Ain't Markup Language), a hash table, a tree structure, and the like.

Meanwhile, the hardware structure described for the server 10 with reference to FIG. 2 may also be a configuration obtained by combining a plurality of electronic components or a plurality of semiconductor devices with each other, or may also be configured of a single IC (Integrated Circuit). All or part of the detection processing unit 12, the cut-out processing unit 13, and the analysis processing unit 14 shown in FIG. 1 may be configured also of an ASIC (Application Specific Integrated Circuit) or an FPGA. The server 10 may also be implemented by a VM (Virtual Machine) having a function thereof implemented by a virtualization technology. Alternatively, the server 10 may also be implemented by a container technology of dividing the processing unit of the server into a plurality of sections, and simultaneously executing a plurality of application software programs. In addition, the hardware configuration of the server 10 is not limited to the configuration shown in FIG. 2, and the server 10 may also have another configuration.

In the case of the first embodiment, the data generation source 110, the management terminal 201, the server 10, and the storage apparatus 120 have separate hardware configurations. The computer system 100 may also be an information processing apparatus obtained by integrating these configurations with each other. In this case, the individual configurations may be implemented by VMs operating in the same computer, may also be implemented by different containers operating on the same OS, or may also be implemented by application software programs operating on the same OS. A plurality of embodiments included in the computer system 100 include the first embodiment in which the data generation source 110 is an image sensor, the server 10 is an edge device, and the storage apparatus 120 is an apparatus including a HDD, but the computer system 100 is not limited thereto.

In addition, in the first embodiment, as described above, through the execution of the program stored in the memory 23 by the processor 21, the function of each of the detection processing unit 12, the cut-out processing unit 13, and the analysis processing unit 14 is performed. It may also be possible that the computer system 100 includes a plurality computers (each of which includes the processor 21 and the memory 23), and the functions of the individual units are performed by the different computers.

### Operation

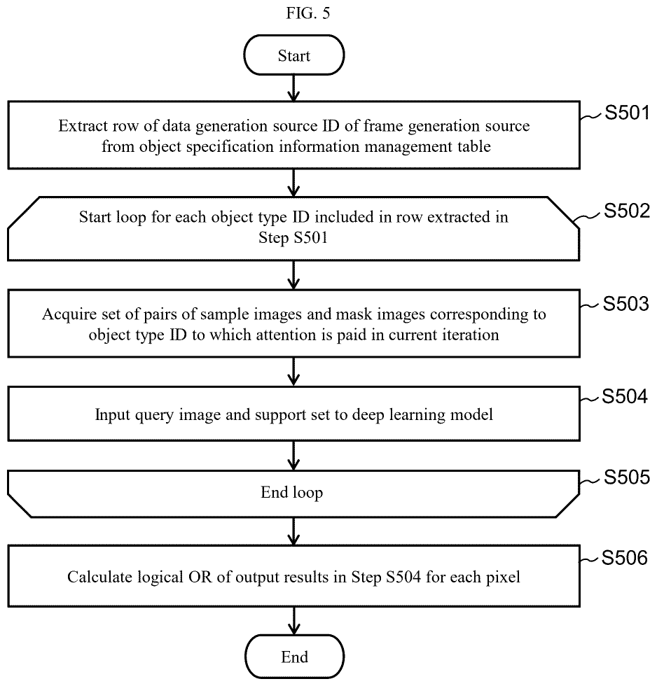

Next, the operation of the computer system 100 in the first embodiment will be described. First, the operation of the detection processing unit 12 shown in FIG. 1 will be described with reference to FIG. 5. FIG. 5 is a flow chart illustrating an example of the operation procedure of the detection processing unit shown in FIG. 1.

The detection program 241 is a program that receives each of the frames 17 as an input, and outputs the detection result 18. By being triggered by, e.g., reading of the frame 17 from the storage apparatus 120, the processor 21 executes the detection program 241. Thus, the processor 21 operates according to the procedure shown by the flow chart in FIG. 5.

In Step S501, the processor 21 extracts, from the object specification information management table 301, the row corresponding to the data generation source ID of the generation source of the frame 17. For example, a consideration will be given of the case where the object specification information management table 301 is the information shown in FIG. 4, and the identifier of the data generation source 110 of the frame 17 is “110A”. In this case, in Step S501, the processor 21 extracts the rows 406 to 408 from the object specification information management table 301.

Steps S502 to S505 are in loop processing that repeats the same processing with respect to the object type ID included in the rows extracted in Step S501. For example, with respect to the table shown in FIG. 4, the processing in Steps S503 to S504 is performed in each of the cases where the object type ID is “obj1” and where the object type ID is “obj2”. In other words, the processor 21 performs the loop processing twice.

In Step S503, the processor 21 acquires, from the object specification information management table 301, a set of the pairs of the sample images 404 and the mask images 405 corresponding to the object type ID to which attention is paid in the current iteration. For example, the case where, in the object specification information management table 301 shown in FIG. 4, the current iteration satisfies Object Type ID=“obj1” will be described. In this case, in Step S503, the processor 21 acquires two sets, which are the support set including the sample image 410 and the mask image 420 and the support set including the sample image 411 and the mask image 421.

In Step S504, by using the set of the pairs of the sample images 404 and the mask images 405 acquired in Step S503 as the support set and using the frame 17 as a query image, the processor 21 inputs the support set and the query image to a deep learning model. The deep learning model is a model that classifies an image from the query image on the basis of the support set, and is, e.g., the FSS model.

The deep learning model receives the query image and the support set as an input, and outputs two-dimensional tensor data representing whether or not the object type specified by the support set is shown for each pixel of the query image. The two-dimensional tensor data in this case is given by Height×Width×Binary Values. The binary values are, e.g., black and white in which the portion of the object type is displayed in black, while the portion other than that of the object type is displayed in white. The support set may include one pair of the sample image and the mask image, and may also include the plurality of pairs of the sample images and the mask images. As the number of the support sets input to the deep learning model increases, the detection accuracy of the image classification improves.

When the execution of all the iterations is completed for the loop processing in Steps S502 to S505, the processor 21 shifts to the processing in Step S506. In Step S506, the processor 21 calculates, for each pixel, the logical OR of calculation results in Step S504 for each of the object type IDs. In other words, the processor 21 generates, in the frame 17, the two-dimensional tensor data indicating the area showing any of one or more object types specified by the object specification information management table 301. When determining the two-dimensional tensor data generated in Step S506 as the detection result 18, the processor 21 ends the detection program 241.

Note that the start trigger of the detection program 241 is not limited to that in the case described above. For example, a consideration will be given of the case where the video data 121 stored in the storage apparatus 120 is video data compressed according to a video compression standard such as H.264. In this case, the start trigger of the detection program 241 is timing at which the processor 21 reads the video data from the storage apparatus 120 and decompressed the video data to the frames 17. The start trigger of the detection program 241 may also be any other timing. The deep learning model used in Step S504 is not limited to the FSS model. The deep learning model may also be, e.g., an Object detection deep learning model using a Few-shot learning technology.

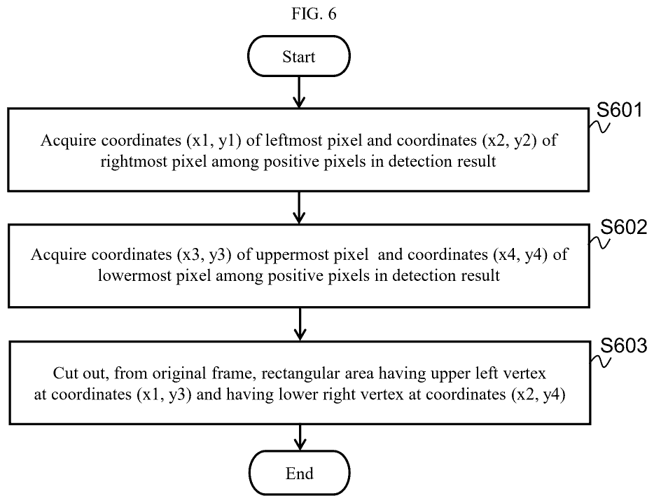

Next, the operation of the cut-out processing unit 13 shown in FIG. 1 will be described with reference to FIG. 6. FIG. 6 is a flow chart illustrating an example of the operation procedure of the cut-out processing unit shown in FIG. 1. The cut-out program 242 is a program that receives the frame 17 and the detection result 18 as an input, and outputs the cut-out image 19. The processor 21 executes the cut-out program 242 by being triggered by, e.g., the completion of the detection program 241. As a result, the processor 21 operates according to the procedure shown by the flow chart in FIG. 6. Note that the start trigger of the execution of the cut-out program 242 is not limited to timing of the completion of the detection program 241.

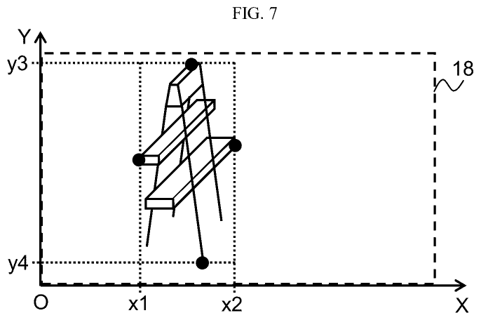

In addition, to a plurality of pixels included in the frame 17 and the image data in the detection result 18, two-dimensional coordinates having a width direction (horizontal direction) as an X-axis and having a height direction (vertical direction) as a Y-axis are applied. FIG. 7 is a diagram illustrating a case where an example of the image in the detection result is represented at the two-dimensional coordinates. The detection result 18 shows the power transmission tower.

In Step S601, the processor 21 acquires, from among the positive pixels, coordinates (x1, y1) of the leftmost pixel and coordinates (x2, y2) of the rightmost pixel at the two-dimensional coordinates to which the detection result 18 is applied. In Step S602, the processor 21 acquires, from among the positive pixels, coordinates (x3, y3) of the uppermost pixel and coordinates (x4, y4) of the lowermost pixel at the two-dimensional coordinates. For the purpose of illustration, FIG. 7 uses black dots to indicate the pixels at the upper end, the lower end, the left end, and the right end among the positive pixels.

In Step S603, the processor 21 cuts out, from the original frame 17, a rectangular area having the upper left at coordinates (x1, y3) and the lower right at coordinates (x2, y4) as the cut-out image 19. In the rectangular cut-out image 19, the two sides that are parallel to the vertical direction are parallel to the two sides of the frame 17 that are parallel to the vertical direction, and the two sides that are parallel to the horizontal direction are parallel to the two sides of the frame 17 that are parallel to the horizontal direction. The cut-out image 19 is the area having the minimum coordinate value of the positive pixels as a lower limit and the maximum coordinate value of the positive pixels as an upper limit for each of the dimensions of the height and the width of the two-dimensional tensor data. When obtaining the cut-out image 19 acquired in Step S603, the processor 21 ends the cut-out program 242.

As a result, all the pixels determined to be positive in the detection processing described with reference to FIG. 5 are included in the cut-out image 19. In addition, it is possible to cut out, as the cut-out image 19, a minimum rectangle having the four sides of the perimeter that are parallel to the respective four sides of the perimeter of the frame 17 from the frame 17.

Note that a method of cutting out, from the frame 17, the area indicating the pixels determined to be positive is not limited to the method described with references to FIGS. 6 and 7. For example, the minimum rectangle including the pixels determined to be positive in the detection result 18 may also be obliquely inclined in the frame 17. In other words, the four sides of the perimeter of the cut-out image 19 need not necessarily be parallel to the four respective sides of the perimeter of the frame 17.

After the cut-out processing, the processor 21 executes the analysis program 243 by being triggered by, e.g., the completion of the cut-out program 242. The processor 21 performs the analysis processing on the cut-out image 19, and outputs the analysis result 102. For example, the processor 21 classifies the image by using the neural network. A detailed description of the analysis processing is omitted herein. The processor 21 may also transmit the analysis result 102 to the management terminal 201 via the front-end interface 20, or may also store the analysis result 102 in the storage apparatus 120. Then, the processor 21 completes the analysis program 243.

In the computer system 100 in the first embodiment, the analysis processing unit 14 analyzes the cut-out image 19 having the amount of data smaller than that of the original frame 17 and, accordingly, the analysis processing time is reduced compared to that in the case of analyzing the original frame 17. In addition, in the first embodiment, as a result of causing the user to specify the object type required for the analysis processing unit 14 via the object type specification interface 101, the cut-out image 19 has an advantage in that the unneeded area is removed from the analysis processing target. For example, a consideration will be given of the case where, when the image of the power transmission tower is input thereto, the analysis processing unit 14 outputs, as the analysis result 102, an inspection result by using a pass or fail binary value about the power transmission tower. When the object type specification information 11 representing the power transmission tower is specified by the user, the area irrelevant to the power transmission tower is removed from the frame 17, and the area of the power transmission tower remains in the cut-out image 19. In the cut-out image 19, the area of the power transmission tower required to inspect the power transmission tower remains, while the other area that is unneeded for the inspection and may become noise to the analysis processing unit 14 is removed. Accordingly, it can be considered that, through the inputting of the cut-out image 19, the analysis processing unit 14 can perform the analysis processing with accuracy equal to or higher than that when the original frame 17 is input. Therefore, it is possible to reduce the analysis processing time, while retaining the accuracy of the analysis processing.

There has conventionally been a case where, in the analysis processing, an image is resized to a fixed resolution, and then the processing is performed. In this case, even when the image input to the analysis processing unit 14 is the cut-out image 19, the resolution of the image input to the neural network or the like is not reduced, and therefore the processing time seems to be unchanged. However, in the first embodiment, the area irrelevant to the analysis processing is cut out from the frame 17, and information which is unneeded for the analysis and may become noise is removed, and therefore it can be considered that the analysis accuracy is improved. It is assumed herein that a relationship such that, as the resolution after the resizing in the analysis processing unit 14 is higher, the accuracy of the analysis thereby is higher is established. At this time, when the cut-out image 19 is input to the analysis processing unit 14, it can be considered that, even though the cut-out image 19 is resized to a lower resolution, accuracy equal to that when the original frame 17 is input thereto can be achieved. Therefore, according to the first embodiment, the processing time can be reduced under the condition that the analysis accuracy is equal even in the analysis processing of resizing the image to a fixed resolution.

Note that, in the first embodiment, the case where the object type specified by the user is extracted from the image data has been described, but the extracted portion is not limited to the image of the object type. The computer system 100 may also perform processing of extracting information required for the user from a huge amount of text data. For example, it may also be possible to use the computer system 100 for the purpose of obtaining information related to the performance of a product from product specifications, while reducing the analysis processing time.

### Variation of Cut-Out Processing

### First Modification

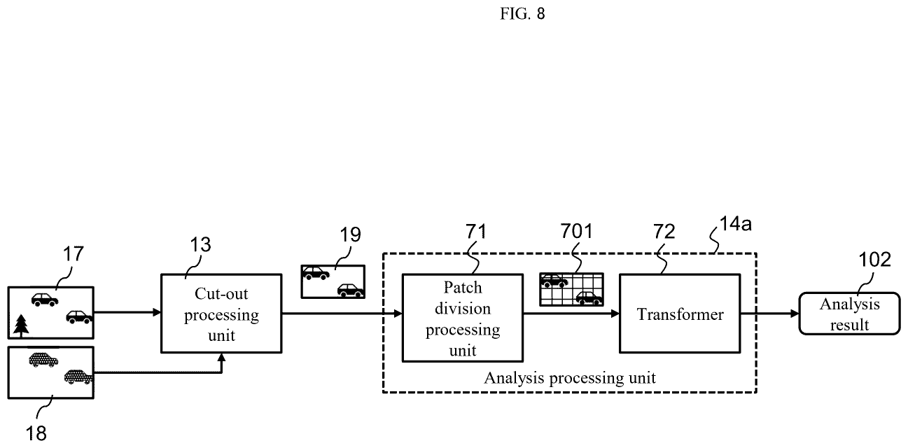

In a first modification, the analysis processing unit 14 divides the cut-out image 19 into a plurality of patches, transforms each of the patches to a token, and then performs the analysis processing. FIG. 8 is a diagram illustrating an example of processing flows in the cut-out processing unit and the analysis processing unit in the first modification. An analysis processing unit 14a in the first modification has a patch division processing unit 71 and a transformer 72. The transformer 72 is an example of the neural network.

As has been described with reference to FIG. 6, the cut-out processing unit 13 transforms the frame 17 and the detection result 18 to the cut-out image 19. When receiving the cut-out image 19 from the cut-out processing unit 13, by using an image classification technology such as ViT, the patch division processing unit 71 transforms the cut-out image 19 to a set of tokens 701, which is a set of data items corresponding to the patches of a predetermined size. For example, the patch division processing unit 71 divides the cut-out image 19 into tile-like square patches measuring 14 pixels vertically and 14 pixels horizontally. Subsequently, the patch division processing unit 71 transforms each of the patches to a vector having a predetermined length by convolutional processing or the like. Then, the patch division processing unit 71 transforms the vectors to the set of tokens 701 in which positional information is embedded in each of the tokens by Positional Encoding. When receiving the set of tokens 701 from the patch division processing unit 71, the transformer 72 performs the analysis processing by using each of the tokens as one word, and outputs the analysis result 102.

According to the first modification, when the specified object type is, e.g., an automobile, the area not showing the automobile is removed by the cut-out processing unit 13. Accordingly, the analysis processing unit 14a can reduce the analysis processing time compared to that when the entire frame 17 is used as the analysis processing target.

### Second Modification

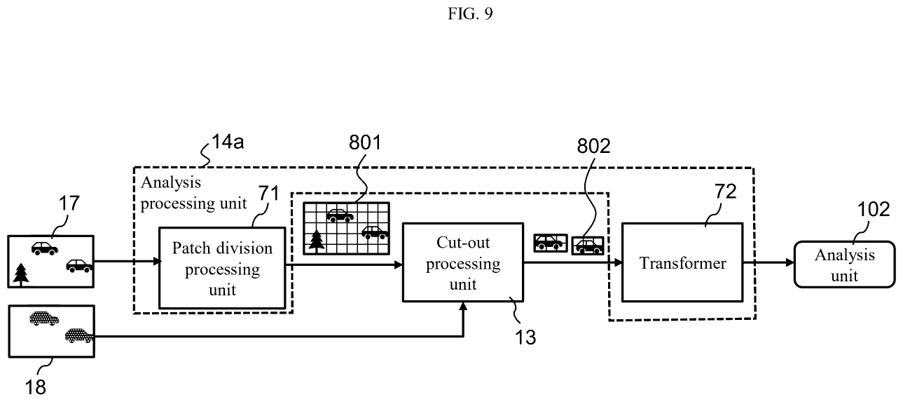

A second modification is obtained by improving the first modification. FIG. 9 is a diagram illustrating an example of processing flows in the cut-out processing unit and the analysis processing unit in the second modification. The analysis processing unit 14a in the second modification has the patch division processing unit 71 that functions as a pre-processing unit and the transformer 72 that functions as a post-processing unit. The cut-out processing unit 13 is provided between the patch division processing unit 71 and the transformer 72.

There are cases where the frame 17 shows two automobiles away from each other, like the frame 17 shown in FIG. 8. In this case, an area showing no automobile, such as an area located between the two automobiles, may remain in the cut-out image 19.

Accordingly, a variation of the cut-out processing unit 13, such as shown in FIG. 9, can be considered. First, the patch division processing unit 71 transforms the entire frame 17 to a set of tokens 801. Subsequently, the cut-out processing unit 13 sorts out, with reference to the detection result 18, only tokens 802 corresponding to a patch in which the one or more positive pixels are present. In the case of the example shown in FIG. 9, there are a plurality of the tokens 802. The cut-out processing unit 13 transmits a set of the sorted tokens 802 to the transformer 72. The transformer 72 performs the analysis processing in the same manner as in the first modification, and outputs the analysis result 102.

According to the second modification, for example, only the tokens 802 corresponding to the patches showing the automobiles are the processing targets of the transformer 72, and therefore calculation efficiency can be improved compared to that in the case described with reference to FIG. 8. In the second modification also, the patch division processing unit 71 has embedded positional information in each of the sorted tokens in the set of tokens 801, and therefore the sorted tokens 802 also retain the positional information. Accordingly, even when the positive pixels are discontinuously scattered in the detection result 18, e.g., when the detection result 18 shows the two automobiles at separate positions, each of the sorted tokens 802 retains the positional information of the two automobiles in the frame 17. Therefore, the transformer 72 can perform analysis considering the positional information of the automobiles in the entire frame 17.

In the cut-out processing unit 13, in addition to the tokens 802 corresponding to the patches showing the automobiles, some of the tokens for the other patches may also be sorted out. For example, by adding the tokens in the fixed area to which the transformer 72 is paying attention as the tokens to be sorted out by the cut-out processing unit 13 irrespective of the image, it is possible to sort out the tokens to be added. For example, when one or more images are input to the analysis processing unit 14a, the cut-out processing unit 13 acquires an Attention value in each of the layers of the transformer 72 or at the position of each of the tokens. Then, the cut-out processing unit 13 acquires an average value of such Attention values for the position of each of the tokens. It can be said that the position of the token at which the average value is larger than a threshold is the area to which the transformer 72 is paying attention irrespective of the image. Accordingly, the cut-out processing unit 13 sorts out, from the set of tokens 801, the token at the position in addition to the tokens 802 in the areas of the automobiles. The threshold is assumed to be, e.g., 1/[Number of Tokens Included in Set of Tokens 801]. As a result, the transformer 72 allows the position of the token, to which the attention is paid, to be specified with a probability higher than that when attention is randomly paid to each of the tokens. Alternatively, the cut-out processing unit 13 may also select the position of the token at which the Attention value in one of the layers of the transformer 72 exceeds the threshold. Note that the method described herein is exemplary, and it may also be possible to, e.g., alternatively, a specified number of tokens may be additionally selected at random from tokens other than the tokens corresponding to the patches showing the automobiles, in the set of tokens 801. Combinations of the above selections may also be used.

Note that the analysis processing unit 14a including the patch division processing unit 71 and the transformer 72 is an example of a configuration in the second modification. Any analysis processing of dividing the image data into a set of subsets and processing the set of the subsets to obtain the analysis result 102 allows the same processing as the processing described with reference to FIG. 9 to be performed.

The computer system 100 in the first embodiment has one or more computers. At least one of the computers includes the memory 23 that stores a program and the processor 21 that performs processing according to the program. The processor 21 performs the detection processing, the cut-out processing, and the analysis processing by executing the program. The detection processing is processing of detecting, when data is input, a portion satisfying the condition specified by the user from the data, and generating the first data indicating the position of the foregoing portion in the data. The cut-out processing is processing of cutting out, from the data, the foregoing portion indicated by the first data to generate the second data. The analysis processing is processing of analyzing the second data.

According to the first embodiment, it is only needed to analyze, in the analysis processing, the cut-out image 19, which is the second data obtained by cutting out the portion satisfying the condition specified by the user from the input image data, and therefore the analysis processing time can be reduced.

### Second Embodiment

In the case of the first embodiment, the analysis processing unit 14 performs the analysis processing on the video data 121, and outputs the analysis result 102. The second embodiment uses the video data 121 to construct a database functioning as external information in RAG. In the second embodiment, the same components as those described in the first embodiment are denoted by the same reference signs, and a detailed description thereof is omitted.

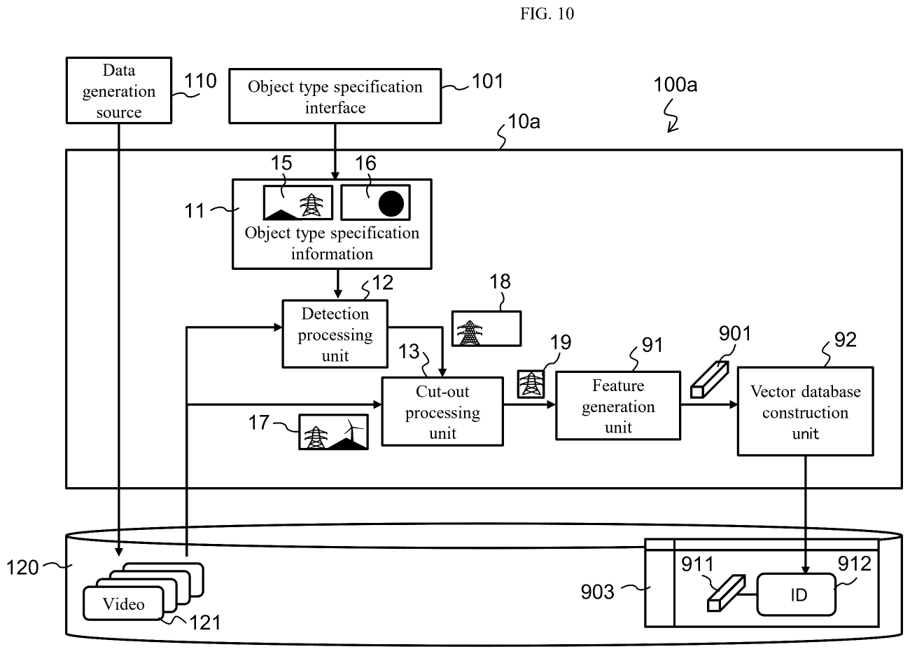

A configuration of a computer system in the second embodiment will be described with reference to FIG. 10. FIG. 10 is a block diagram illustrating a configuration example of the computer system in the second embodiment. A computer system 100a in the second embodiment includes a server 10a instead of the server 10 shown in FIG. 1. The server 10a includes the detection processing unit 12, the cut-out processing unit 13, a feature generation unit 91, and a vector database construction unit 92. In the second embodiment, the feature generation unit 91 functions as the analysis processing unit.

When image data is input thereto, the feature generation unit 91 outputs an embedding, which is a vector representing a feature of the area of the object type or the like. For example, the feature generation unit 91 performs, on the image data, processing using the ViT constructed on the basis of a transformer, and outputs a class token, which is a vector representing a feature of an image. The processing by the feature generation unit 91 is not limited to that in the case described above. In the second embodiment, the cut-out image 19 is input as the image data to be analyzed to the feature generation unit 91. When receiving the cut-out image 19 from the cut-out processing unit 13, the feature generation unit 91 derives an embedding 901 including the feature of the area of the object type specified by the user, and outputs the embedding 901 to the vector database construction unit 92.

The vector database construction unit 92 is implemented by the processor 21 by executing a vector database software program. The memory 23 shown in FIG. 2 stores the vector database software program. The embedding 901 is input from the feature generation unit 91 to the vector database construction unit 92. The vector database construction unit 92 uses the embedding 901 as a key 911 and uses the identifier of the frame 17 as a value 912 to write the key 911 and the value 912 in association with each other in a vector database 903. The identifier of the frame 17 is configured to include, e.g., a path on a file system of the video data 121 and a serial number of the frame 17 in the video data 121. The identifier of the frame 17 is not limited to this configuration.

Alternatively, the vector database construction unit 92 may also determine the one embedding 901 for a plurality of the frames 17. In this case, the vector database construction unit 92 may also use, as the value 912, the identifier of a video configured to include the plurality of frames 17 with respect to the key 911 of the one embedding 901, and write the key 911 and the value 912 in association with each other in the vector database 903.

Search processing using the vector database 903 is processing of returning, to a vector given as a search condition, the value 912 associated with the most similar key 911 according to an index such as, e.g., a cosine similarity. When the user inputs the search condition to the server 10a, the server 10a reads the frame that matches the search condition from the vector database 903, and inputs the read frame and search condition to an external generative AI. The generative AI is, e.g., an LLM (Large Language Model). In this case, the user can obtain a more accurate answer from the generative AI. The generative AI may also be stored in the storage apparatus 120.

Note that, to the second embodiment, the second modification may also be applied. As described with reference to FIG. 9, the server 10a may also determine the embedding 901 by performing the division processing using the patch division processing unit 71, performing the cut-out processing using the cut-out processing unit 13, and then performing the processing using the transformer 72.

According to the second embodiment, in the analysis processing, the feature is extracted from the image by using the ViT, and accordingly the processing time can be reduced. In addition, the vector database 903 functions as a search system that uses the embedding of, e.g., an image, a video, or a text as the search condition to return the frame of the video similar to the search condition. Furthermore, the vector database 903 can be used as external information in RAG. For example, when the text of a question from the user is input thereto, the server 10a uses the vector database 903 to search for a frame similar to the details of the text. Then, the server 10a inputs the frame obtained as a result of the search and the text of the question from the user to the LLM, and provides an output of the LLM to the user. By performing retrieval-augmented generation, it is possible to improve the accuracy of an answer from the LLM.

### Third Embodiment

The third embodiment compresses the image data to be stored in the storage apparatus 120. In the third embodiment, the same components as those described in the first and second embodiments are denoted by the same reference signs, and a detailed description thereof is omitted. In addition, in the third embodiment, a description will be given on the basis of the computer system 100a described in the second embodiment, but a base configuration is not limited to that in the second embodiment.

### Configuration

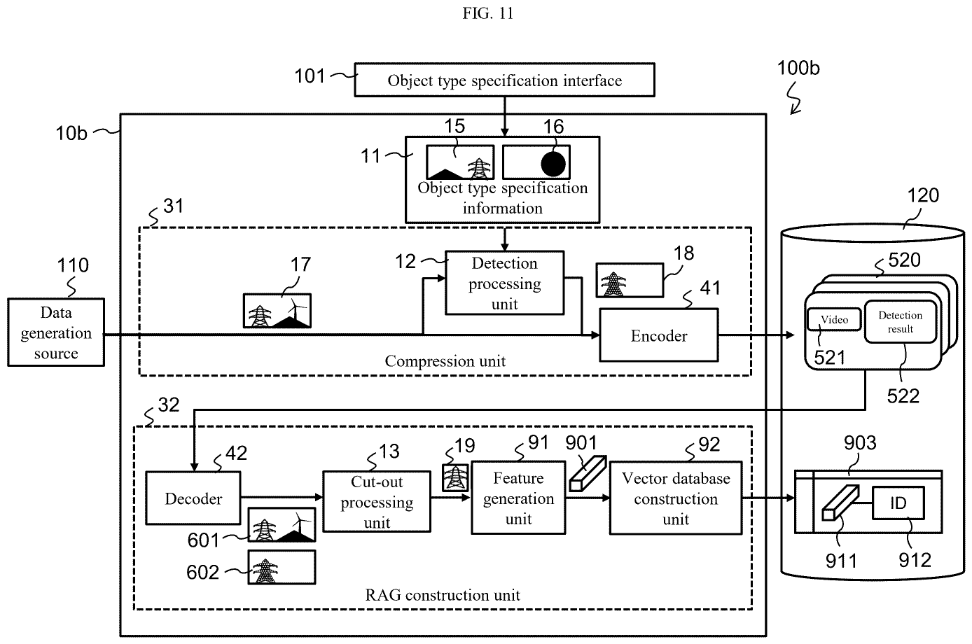

A configuration of a computer system in the third embodiment will be described with reference to FIG. 11. FIG. 11 is a block diagram illustrating a configuration example of the computer system in the third embodiment. A computer system 100b in the third embodiment includes a server 10b instead of the server 10 shown in FIG. 1. The server 10b includes a compression unit 31 and a RAG construction unit 32.

The compression unit 31 compresses the video data generated by the data generation source 110 by using a video compression technology, and stores data 520 including the compressed video data in the storage apparatus 120. The video compression technology is the technology disclosed in Japanese Patent Application Publication No. 2024-145685. The compression unit 31 compresses the video data generated by the data generation source 110. In the third embodiment, the compression unit 31 compresses the video data generated by the data generation source 110 by increasing the number of bits to be allocated to the area of the object type specified by the user, and reducing the number of bits to be allocated to the area other than that of the object type. In other words, the compression unit 31 provides the area of the object type with a high image quality, and provides the area other than that of the object type with a low image quality to reduce the amount of data in each of the plurality of frames 17 included in the video data. Thus, a high compression ratio is achieved, and the amount of data stored in the storage apparatus 120 is reduced. The compression unit 31 has the detection processing unit 12 and the encoder 41 that performs compression processing of compressing the image data.

The RAG construction unit 32 uses the data 520 stored in the storage apparatus 120 to construct the vector database 903. The RAG construction unit 32 includes a decoder 42 that performs decompression processing of decompressing the compressed image data, the cut-out processing unit 13, the feature generation unit 91, and the vector database construction unit 92.

### Operation

When receiving the video data from the data generation source 110, the compression unit 31 inputs each of the frames 17 to the detection processing unit 12. In the same manner as in the first embodiment, the detection processing unit 12 generates binary data indicating a positive area showing the object type specified by the user and a negative area showing something other than the object type, and outputs the binary data as the detection result 18 to the encoder 41. When the frame 17 and the detection result 18 are input thereto, the encoder 41 provides the portion of the frame 17 that corresponds to the positive area in the detection result 18 with a high image quality, and provides the portion of the frame 17 that corresponds to the negative area in the detection result 18 with a low image quality, while reducing the amount of data in the frame 17. Specifically, the encoder 41 increases the number of bits to be allocated to the portion of the frame 17 that corresponds to the positive area in the detection result 18, and reduces the number of bits to be allocated to the portion of the frame 17 that corresponds to the negative area in the detection result 18. The encoder 41 controls the image quality and the amount of data for each of the areas of the frame 17 to compress the frame 17.

Then, the encoder 41 stores, in the storage apparatus 120, the data 520 obtained by associating video data 521 after the compression with a detection result 522 calculated in the process of the compression. The detection result 522 may also be tensor data representing the detection result 18 in the Raw format, may also be a bit string obtained by encoding the detection result 18 according to a Run-length method or the like, or may also be another data structure. The video data 521 after the compression and the detection result 522 in each of the data items 520 may also be associated with each other in any data structure. For example, it may be possible to provide each of the video data 521 after the compression and the detection result 522 with the same file name, and store these data items in different folders in the storage apparatus 120. Alternatively, it may also be possible to embed the detection result 522 as meta data in the container of video data defined according to a standard such as, e.g., MPEG-7.

When the RAG construction unit 32 receives the data 520 from the storage apparatus 120, the decoder 42 decodes the data 520 to a plurality of frames 601 included in the video data and a detection result 602. When the frames 601 and the detection result 602 are input thereto, the cut-out processing unit 13 generates the cut-out image 19, as described with reference to, e.g., FIG. 6. Then, the feature generation unit 91 determines the embedding 901 including the feature of the area of the object type from the cut-out image 19 in the same manner as in the second embodiment, and outputs the embedding 901 to the vector database construction unit 92. The vector database construction unit 92 constructs the vector database 903 in the storage apparatus 120 in the same manner as in the second embodiment.

According to the third embodiment, the image data to be analyzed is stored in the storage apparatus in a state where the area of the object type has a high image quality, and accordingly the accuracy of the analysis processing is improved. Note that the detection result 602 to be used by the cut-out processing unit 13 is obtained by decoding the detection result 18 used by the compression unit 31. Therefore, in the RAG construction unit 32, the detection processing unit 12 need not perform processing, and RAG construction processing time can be reduced to be shorter than that in the second embodiment. Furthermore, by using the video compression technology disclosed in Japanese Patent Application Publication No. 2024-145685, the video data is compressed and stored in the storage apparatus 120 and, accordingly, the amount of data stored in the storage apparatus 120 can be reduced to be smaller than that in the second embodiment. As a result, the storage apparatus 120 can be used more effectively.

### Fourth Embodiment

The fourth embodiment implements the function of the server described in the first to third embodiments by using a group of microservices. In the fourth embodiment, the same components as those described in the first to third embodiments are denoted by the same reference signs, and a detailed description thereof is omitted. In addition, in the fourth embodiment, a description will be given on the basis of the computer system 100b described in the third embodiment, but a base configuration is not limited to that in the third embodiment.

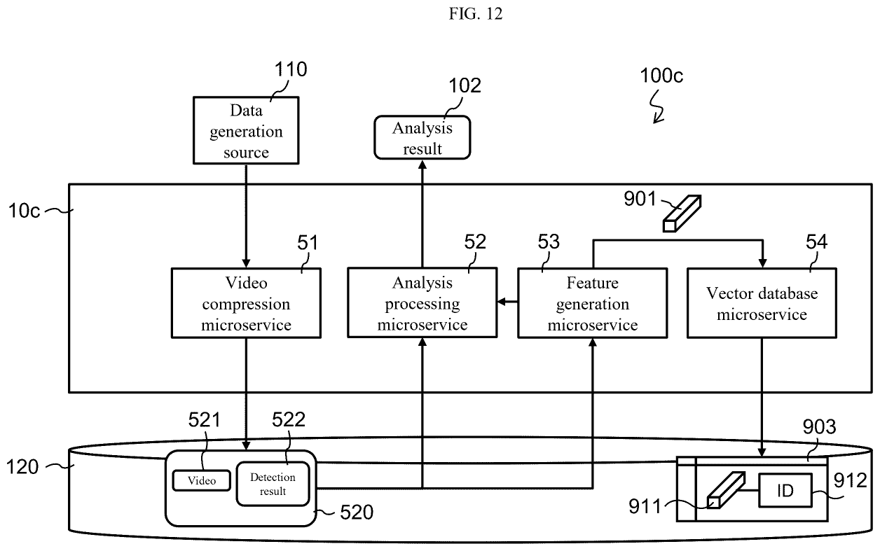

A configuration of a computer system in the fourth embodiment will be described with reference to FIG. 12. FIG. 12 is a block diagram illustrating a configuration example of the computer system in the fourth embodiment. A computer system 100c in the fourth embodiment includes a server 10c instead of the server 10 shown in FIG. 1. The server 10c includes a video compression microservice 51, an analysis processing microservice 52, a feature generation microservice 53, and a vector database microservice 54.

The computer system 100c is a configuration including a plurality of computers. Each of the computers includes the processor 21 and the memory 23 each shown in FIG. 2, and performs the function of one of the microservices. FIG. 12 illustrates a case where the plurality of computers are provided on the single server 10c. The plurality of computers need not necessarily be provided in the single server 10c, and may also be coupled to each other via a network such as the Internet.

The video compression microservice 51 is a microservice that performs the processing in the compression unit 31 in the third embodiment. The video compression microservice 51 receives the video data from the data generation source 110, compresses the received video data, and stores the data 520 obtained by associating the video data 521 after the compression with the detection results 522 of each of the frames in the storage apparatus 120.

The analysis processing microservice 52 is a microservice that performs the processing in the analysis processing unit 14. The analysis processing microservice 52 receives, e.g., the data 520 stored in the storage apparatus 120 as an input, transforms each of the frames to the cut-out image 19 by the cut-out processing, performs the analysis processing on the cut-out image 19, and outputs the analysis result 102.

The feature generation microservice 53 is a microservice that performs, when the data 520 is input, processing from the decoder 42 of the RAG construction unit 32 to the feature generation unit 91 in the third embodiment, and outputs the embedding 901. The feature generation microservice 53 may also output the embedding 901 to the analysis processing microservice 52. This is because the processing by the feature generation microservice 53 corresponds to the analysis processing.

The vector database microservice 54 is a microservice that constructs the vector database 903. Alternatively, the vector database microservice 54 may also function as external information in RAG.

Note that the microservices shown in FIG. 12 are exemplary and, instead of the microservices, a virtual machine, software operating in a user space, a library operating on the same software, a function on the same software, or the like may also be used.

According to the fourth embodiment, it is possible to couple the plurality of microservices with each other via a network such as the Internet. Accordingly, the user need not provide the server managed thereby with the plurality of microservices. For example, the user can select, from among the plurality of microservices provided outside, the microservice that provides the server managed by the user with a required function. As a result, the versatility the details of which are disclosed in the first to third embodiment is improved.

The embodiments described above are shown by way of example for the description of the present invention, and are not intended to limit the scope of the present invention only to the embodiments described above. A person skilled in the art could implement the present invention in various other forms, such as by changing a specific configuration, within the scope not departing from the concept and the gist of the present invention.

In addition, the embodiments described above include the following matters. However, the matters included in the present embodiment are by no means limited to those shown below.

### Matter 1

A computer system including one or more computers to analyze data, wherein at least one of the computers includes: a memory configured to store a program; and a processor configured to perform processing according to the program, and wherein the processor executes the program to perform: detection processing of detecting, when the data is input, a portion that satisfies a condition specified by a user from the data, and generating first data indicating a position of the portion in the data; cut-out processing of cutting out, from the data, the portion indicated by the first data, and generating second data; and analysis processing of analyzing the second data.

Accordingly, it is only needed to analyze the second data obtained by cutting out, from the input data, the portion that satisfies the condition specified by the user in the analysis processing, and therefore the analysis processing time can be reduced.

### Matter 2

The computer system according to Matter 1, wherein, when the data is image data of a video or a still image, as the detection processing, the processor transforms the image data to the first data, which is binary data including a first value indicating a pixel representing an object type specified by the user and a second value indicating a pixel representing an area other than that of the object type, and wherein, as the cut-out processing, the processor refers to the first data and cuts out, from the image data, the second data including an area indicating the first value.

Accordingly, the pixel representing the object type specified by the user is recognized in the image data, and the portion including the area of the object type is cut out from the image data as an analysis processing target. As a result, in the analysis processing, it is only needed to analyze the portion of the image data that includes the object type, and therefore the analysis processing time can be reduced.

### Matter 3

The computer system according to Matter 2, wherein, when the image data is tensor data, as the cut-out processing, the processor cuts out, from the image data, an area having a minimum coordinate value of the pixel of the first value as a lower limit and having a maximum coordinate value of the pixel of the first value as an upper limit for each of dimensions of a height and a width of the tensor data, and generates the second data.

As a result, in the image data, by the coordinates of the pixels having the maximum value and the minimum value in a height direction, the upper end and the lower end of the area of the second data are specified and, by the coordinates of the pixels having the maximum value and the minimum value in a width direction, a left end and a right end of the area of the second data are specified.

### Matter 4

The computer system according to Matter 2 or 3, wherein, when the image data is tensor data, as a stage previous to the analysis processing, the processor divides the image data into a set of tokens, wherein, as the cut-out processing, the processor cuts out the token which is included in the set of the tokens and which corresponds to a patch including one or more pixels of the first value, and wherein, as a stage subsequent to the analysis processing, the processor inputs a set of the cut-out tokens to a neural network and acquires the second data from the neural network.

As a result, the analysis processing can be performed even on an image showing a plurality of object types at positions away from each other by using data obtained by removing an area showing no object type. Therefore, the analysis processing time can be reduced.

### Matter 5

The computer system according to Matter 4, wherein, among the set of the tokens, the processor cuts out, in addition to the token corresponding to the patch including the one or more pixels of the first value, the token at a position to which attention is paid by the neural network.

This allows the neural network to specify the position of the token to which attention is paid with a probability higher than that when attention is randomly paid to each of the tokens.

### Matter 6

The computer system according to any one of Matters 2 to 5, further including: a storage apparatus configured to store the image data, wherein, as the analysis processing, the processor obtains, from the second data, an embedding including a feature of the object type, and wherein the processor uses the embedding as a key and uses an identifier of the image data as a value so as to construct, in the storage apparatus, a vector database in which the key is associated with the value.

As a result, the vector database that stores the embedding including the object type specified by the user and the identifier of the image data in association with each other is constructed in the storage apparatus. The vector database can be used as external information for a retrieval-augmented generation technology.

### Matter 7

The computer system according to Matter 6, wherein the processor performs, on the basis of the first data, which is a detection result of the detection processing, compression processing of providing the area of the object type with a high image quality and providing an area other than that of the object type with a low image quality so as to compress the image data, and storing in the storage apparatus the compressed image data in association with the detection result, wherein the processor performs decompression processing of decompressing the compressed image data by using the detection result, wherein the processor performs the cut-out processing by using the decompressed image data and the detection result, and wherein the processor performs the analysis processing on the second data.

As a result, the image data to be analyzed is stored in the storage apparatus, while the area of the object type has a high image quality, and the amount of data stored in the storage apparatus is reduced. Therefore, not only the accuracy of the analysis processing is improved, but also the storage apparatus can be used more effectively.

### Matter 8

The computer system according to any one of Matters 2 to 7, wherein the memory stores management information including a support set, which is a pair of a sample image showing the object type to be detected by a deep learning model for classifying an image and mask data indicating an area showing the object type in the sample image, and wherein, as the detection processing, the processor inputs the management information and the image data to the deep learning model, and acquires the first data from the deep learning model.

As a result, to the deep learning model, the image data serving as a query image and the management information including information on the object type are input, and therefore the deep learning model can classify a portion more closer to the object type in the image data.

### Matter 9

The computer system according to Matter 8, further including an interface for configuring the management information.

Accordingly, the user can specify the object type by using the interface for configuring the management information.

### Matter 10

A computer system including: the computer according to any one of Matters 1 to 9; and a storage apparatus configured to store the data.

Thus, the storage apparatus for storing data to be subjected to analysis processing is included, and therefore the user can independently store data appropriate for the analysis processing in the storage apparatus.

### Matter 11

The computer system according to any one of Matters 1 to 10, wherein the one or more computers are a single computer.

This allows the single computer to reduce the analysis processing time, and therefore resources can be used efficiently.

What is claimed is:

1. A computer system comprising one or more computers to analyze data,
wherein at least one of the computers includes:
a memory configured to store a program; and
a processor configured to perform processing according to the program, and
wherein the processor executes the program to perform:
detection processing of detecting, when the data is input, a portion that satisfies a condition specified by a user from the data, and generating first data indicating a position of the portion in the data;
cut-out processing of cutting out, from the data, the portion indicated by the first data, and generating second data; and
analysis processing of analyzing the second data.

2. The computer system according to claim 1,
wherein, when the data is image data of a video or a still image, as the detection processing, the processor transforms the image data to the first data, which is binary data including a first value indicating a pixel representing an object type specified by the user and a second value indicating a pixel representing an area other than that of the object type, and
wherein, as the cut-out processing, the processor refers to the first data and cuts out, from the image data, the second data including an area indicating the first value.

3. The computer system according to claim 2,
wherein, when the image data is tensor data, as the cut-out processing, the processor cuts out, from the image data, an area having a minimum coordinate value of the pixel of the first value as a lower limit and having a maximum coordinate value of the pixel of the first value as an upper limit for each of dimensions of a height and a width of the tensor data, and generates the second data.

4. The computer system according to claim 2,
wherein, when the image data is tensor data, as a stage previous to the analysis processing, the processor divides the image data into a set of tokens,
wherein, as the cut-out processing, the processor cuts out the token which is included in the set of the tokens and which corresponds to a patch including one or more pixels of the first value, and
wherein, as a stage subsequent to the analysis processing, the processor inputs a set of the cut-out tokens to a neural network and acquires the second data from the neural network.

5. The computer system according to claim 4,
wherein, among the set of the tokens, the processor cuts out, in addition to the token corresponding to the patch including the one or more pixels of the first value, the token at a position to which attention is paid by the neural network.

6. The computer system according to claim 2, further comprising:
a storage apparatus configured to store the image data,
wherein, as the analysis processing, the processor obtains, from the second data, an embedding including a feature of the object type, and
wherein the processor uses the embedding as a key and uses an identifier of the image data as a value so as to construct, in the storage apparatus, a vector database in which the key is associated with the value.

7. The computer system according to claim 6,
wherein the processor performs, on the basis of the first data, which is a detection result of the detection processing, compression processing of providing the area of the object type with a high image quality and providing an area other than that of the object type with a low image quality so as to compress the image data, and storing in the storage apparatus the compressed image data in association with the detection result,
wherein the processor performs decompression processing of decompressing the compressed image data by using the detection result,
wherein the processor performs the cut-out processing by using the decompressed image data and the detection result, and
wherein the processor performs the analysis processing on the second data.

8. The computer system according to claim 2,
wherein the memory stores management information including a support set, which is a pair of a sample image showing the object type to be detected by a deep learning model for classifying an image and mask data indicating an area showing the object type in the sample image, and
wherein, as the detection processing, the processor inputs the management information and the image data to the deep learning model, and acquires the first data from the deep learning model.

9. The computer system according to claim 8, further comprising an interface for configuring the management information.

10. A computer system comprising:
the computer according to claim 1; and
a storage apparatus configured to store the data.

11. The computer system according to claim 1,
wherein the one or more computers are a single computer.

12. A data processing method to be implemented by a computer system, the data processing method comprising:
detecting, when data is input, a portion that satisfies a condition specified by a user from the data and generating first data indicating a position of the portion in the data;
cutting out, from the data, the portion indicated by the first data and generating second data; and
analyzing the second data.

13. A non-transitory computer readable medium storing a program for causing a computer to:
detect, when data is input, a portion that satisfies a condition specified by a user from the data and generate first data indicating a position of the portion in the data;
cut out, from the data, the portion indicated by the first data and generate second data; and
analyze the second data.
